(19) United States
(12) Patent Application Publication
(10) Pub. No.: US 2010/0012474 A1
(43) Pub. Date: Jan. 21, 2010

(54) Structure having symbols printed thereon and method for implementing the same

(75) Inventor: Ching Cheng Tsai, Taipei (TW)

Correspondence Address: BACON & THOMAS, PLLC, 625 SLATERS LANE, FOURTH FLOOR, ALEXANDRIA, VA, 22314-1176, US

(73) Assignee: CHICONY ELECTRONICS CO., LTD, Taipei Hsien (TW)

(21) Appl. No.: 12/453,851

(22) Filed: May 26, 2009

(30) Foreign Application Priority Data
Jul. 17, 2008 (TW) 97127096

(51) Int. Cl. H01H 13/14; B41F 17/00

(52) U.S. Cl. 200/341; 101/35

(57) ABSTRACT

The present invention provides a structure having symbols printed thereon, the structure being a keyboard. The keyboard comprises: at least one keycap; at least one symbol printed on the surface of the keycap; and at least one first protective layer having a plurality of reticulate dots, the first protective layer being formed over the symbol on the surface of the keycap. The invention further provides a method for printing symbols on a keyboard, comprising the steps of: printing a plurality of symbols on the surface of the keycap of the keyboard; and forming a first protective layer having a plurality of reticulate dots over the plurality of symbols on the surface of the keycap of the keyboard.

### BACKGROUND OF THE INVENTION

1. Field of the Invention

The present invention relates to a structure having symbols printed thereon and a method for implementing the same, and more particularly, to a structure and a method that facilitate increasing the abrasion resistance of the symbols printed on the surface of the keycap so as to prevent the symbols from detaching from the surface of the keycap and to prolong the lifetime of the keyboard.

2. Description of the Related Art

With the popularity of computer, users not only pursue better computer efficiency but also pay more attention to the function and design of computer accessories such as mouse and keyboard. As computer has become an indispensable device in nearly every aspect of modern life from telecommunication, commerce, editing to graphics design, much effort has been done to improve the performance of the keyboard, one of the most important input devices for computer.

As a keyboard has limited space for the installation of keycaps, the surface of each keycap is usually printed with one to four symbols, allowing the user to shift between various input methods. Generally, a protective layer is formed over the symbols printed on the surface of the keycap to increase the abrasion resistance of the symbols, but such a protection is inadequate. If the printed symbols become worn and unrecognizable due to excessive use, the user will not be able to use the keyboard properly and have to replace it with a new one.

It is environmental unfriendly and wasteful that a keyboard is discarded simply because the symbols on the keycap become worn. Thus, more work remains to be done to improve the abovementioned disadvantages of the conventional keyboard.

### SUMMARY OF THE INVENTION

The object of the present invention is to provide a structure having symbols printed thereon and a method for implementing the same; wherein the structure is a keyboard; and wherein a plurality of symbols are printed on the surface of a keycap of a keyboard via screen printing, and then a first protective layer having a plurality of reticulate dots is formed over the plurality of symbols on the surface of the keycap via transfer printing. The structure and method of the present invention may reduce the complexity of the manufacturing process, lower the costs, increase the yield of the product, and improve the abrasion resistance of the symbols on the surface of the keycap so as to prevent the symbols from detaching from the surface of the keycap. Furthermore, the first protective layer having a plurality of reticulate dots of the present invention may also prolong the lifetime of the conventional keyboard.

To achieve the aforementioned objects of the present invention, there is provided a structure having symbols printed thereon, the structure being a keyboard. The keyboard comprises: at least one keycap; at least one symbol printed on the surface of the keycap; and at least one first protective layer having a plurality of reticulate dots, the first protective layer being formed over the symbol printed on the surface of the keycap.

Preferably a second protective layer is further provided between the symbol and the first protective layer.

Preferably the reticulate dots are granular protrusions.

In addition, in order to achieve the aforementioned objects of the present invention, there is provided a method for printing symbols on a keyboard comprising a plurality of keycaps. The method includes the steps of: printing a plurality of symbols on the surface of a corresponding keycap of the keyboard; and forming a first protective layer having a plurality of reticulate dots over the plurality of symbols printed on the surface of the keycap of the keyboard.

Preferably the plurality of symbols are printed on the surface of the keycap of the keyboard via screen printing.

Preferably the first protective layer is formed over the plurality of symbols on the surface of the keycap of the keyboard via transfer printing.

Preferably the reticulate dots are granular protrusions.

A method for printing symbols on a keyboard comprising a plurality of keycaps includes the steps of: printing a plurality of symbols on the surface of a corresponding keycap of the keyboard; forming a first protective layer having a plurality of reticulate dots over the plurality of symbols on the surface of the keycap of the keyboard; and forming a second protective layer between the plurality of symbols and the first protective layer.

Preferably the plurality of symbols are printed on the surface of the keycap of the keyboard via screen printing.

Preferably the first protective layer is formed by means of transfer printing.

Preferably the second protective layer is formed by means of screen printing.

Preferably the reticulate dots are granular protrusions.

### BRIEF DESCRIPTION OF THE DRAWINGS

FIG. 1 is a top view showing a structure having symbols printed thereon of the present invention.

FIG. 2 is an enlarged view of a keycap.

FIG. 3 is a cross-sectional view showing the first embodiment of a keycap taken along line A-A of FIG. 2.

FIG. 4 is a cross-sectional view showing the second embodiment of a keycap taken along line A-A of FIG. 2.

FIG. 5 is an enlarged view of a keycap.

FIG. 6 is a flow chart showing the first embodiment of a method for printing symbols on a keyboard according to the present invention.

FIG. 7 is a flow chart showing the second embodiment of a method for printing symbols on a keyboard according to the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

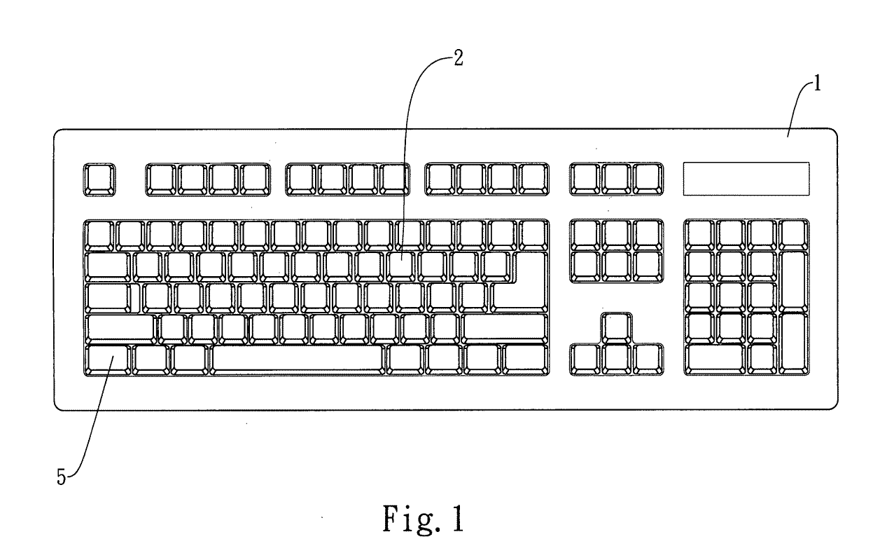

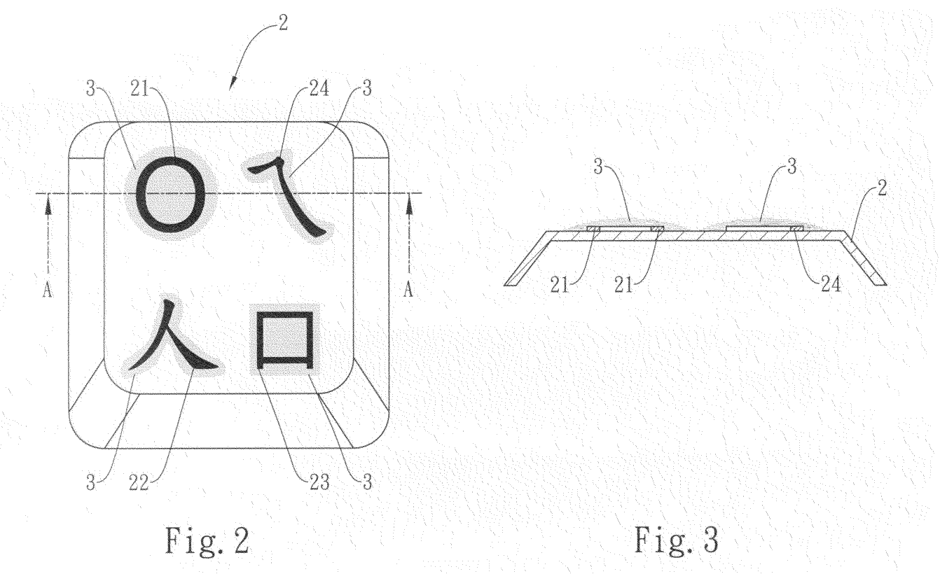

FIG. 1 is a top view showing a structure having symbols printed thereon of the present invention. FIG. 2 is an enlarged view of the keycap 2 shown in FIG. 1. In the first embodiment of the present invention, the structure having symbols printed thereon is a keyboard 1. The keyboard 1 comprises: a plurality of keycaps 2; a plurality of symbols 21, 22, 23, 24 printed on the surface of a corresponding keycap 2; and at least one first protective layer 3 having a plurality of reticulate dots, the first protective layer being printed over the symbols 21-24 on the surface of the keycap 2; wherein a plurality of granular protrusions/reticulate dots are formed on the surface of the first protective layer 3 after the first protective layer 3 has dried.

FIG. 3 is a cross-sectional view showing the first embodiment of a keycap 2 taken along line A-A of FIG. 2. In this embodiment, a keycap 2 printed with a plurality of symbols 21-24 represents a group of similar keycaps on the keyboard and is used for illustration. The four symbols 21, 22, 23 and 24 printed on the surface of the keycap 2 represent the English letter “O”, the Chinese radical [symbol] (denoting human) in the Tsang-Jye Input Method, the Chinese radical [symbol] (denoting mouth) in the Da-Yi Input Method, and the phonetic symbol [symbol] in the Phonetic Input Method, respectively, and the first protective layer 3 having a plurality of reticulate dots is formed over the symbols 21-24 on the surface of the keycap 2. As the reticulate dots can improve the abrasion resistance of the first protective layer 3, the first protective layer 3 can effectively prevent the symbols 21-24 from detaching from the surface of the keycap 2.

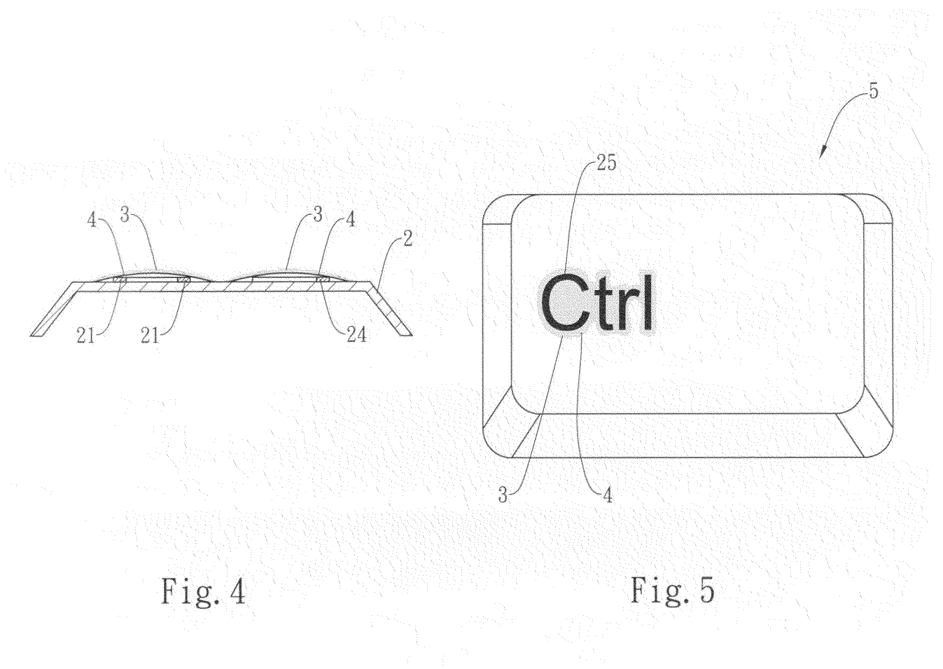

FIG. 4 is a cross-sectional view showing the second embodiment of a keycap 2 taken along line A-A of FIG. 2. In this embodiment, a second protective layer 4 is further provided between the symbols 21-24 and the first protective layer 3.

The first and second protective layers 3 and 4 are configured to increase the abrasion resistance of the symbols 21-24 on the surface of the keycap 2, thereby to prevent the symbols 21-24 from detaching from the surface of the keycap 2 and to prolong the lifetime of the keyboard 1.

FIG. 5 is an enlarged view of a keycap 5. In this preferred embodiment, a symbol 25 “Ctrl” is printed on the surface of the keycap 5, with the first protective layer 3 having a plurality of reticulate dots being formed over the symbol 25 and the second protective layer 4 being disposed between the symbol 25 and the first protective layer 3; wherein both the first and second protective layers 3 and 4 are disposed surrounding the symbol 25 “Ctrl”.

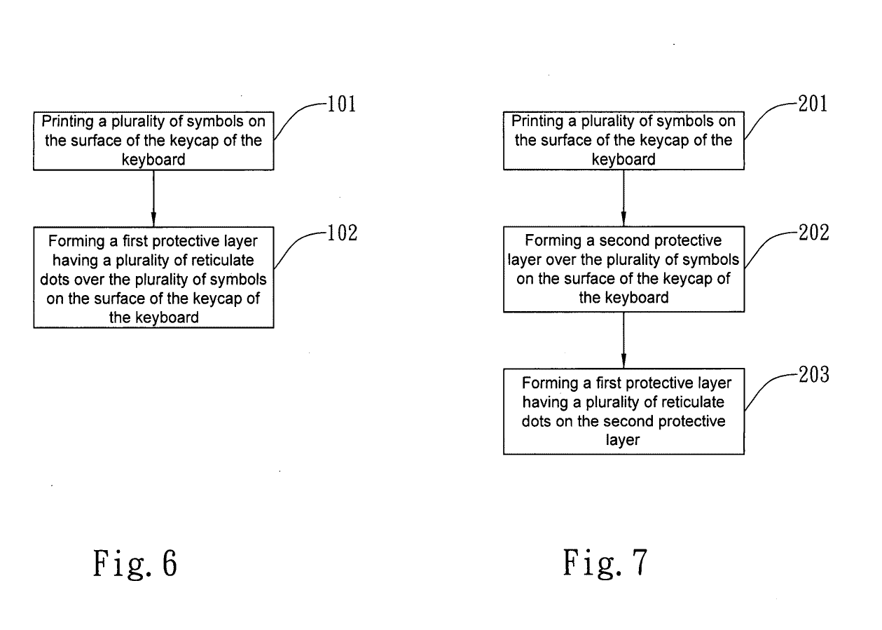

FIG. 6 is a flow chart showing the first embodiment of a method for printing symbols on a keyboard according to the present invention, and it will be clearer to also refer to FIG. 1. In this embodiment, the method for printing symbols on a keyboard based on the structure having symbols printed thereon comprises the following steps:

In step 101, a plurality of symbols 21-24 are printed on the surface of the keycap 2 of the keyboard 1 via screen printing.

In step 102, a first protective layer 3 having a plurality of reticulate dots is formed over the plurality of symbols 21-24 on the surface of the keycap 2 of the keyboard 1 via transfer printing.

FIG. 7 is a flow chart showing the second embodiment of a method for printing symbols on a keyboard according to the present invention, and it will be clearer to also refer to FIG. 1. In this embodiment, the method for printing symbols on a keyboard based on the structure having symbols printed thereon comprises the following steps:

In step 201, a plurality of symbols 21-24 are printed on the surface of the keycap 2 of the keyboard 1 via screen printing.

In step 202, a second protective layer 4 is formed over the plurality of symbols 21-24 on the surface of the keycap 2 of the keyboard 1 via screen printing.

In step 203, a first protective layer 3 having a plurality of reticulate dots is formed on the second protective layer 4 via transfer printing.

The first protective layer 3 having a plurality of reticulate dots is proved to be highly abrasion resistant after the structure having symbols printed thereon of the present invention underwent the falling carborundum test. A plurality of granular protrusions/reticulate dots are formed on the surface of the first protective layer after the first protective layer printed over the symbols has dried such that the first protective layer having a plurality of reticulate dots can prevent the symbols from detaching from the surface of the keycap. Therefore, the structure having symbols printed thereon and the method for implementing the same of the present invention can facilitate reducing the manufacturing process, lowering the costs, increasing the yield of the product, and improving the abrasion resistance of the symbols on the surface of the keycap so as to prevent the symbols from detaching from the surface of the keycap and to prolong the lifetime of the keyboard.

While this invention has been described by way of examples and in terms of preferred embodiments, it is to be understood that this invention is not limited hereto, and that various changes, substitutions, and alterations can be made herein without departing from the spirit and scope of this invention as defined by the appended claims. Please refer to the claims for the coverage of the rights of the present invention.

What is claimed is:

1. A structure having symbols printed thereon, the structure being a keyboard comprising:
at least one keycap;
at least one symbol printed on the surface of the keycap; and
at least one first protective layer having a plurality of reticulate dots, the first protective layer being formed over the symbol on the surface of the keycap.

2. The structure having symbols printed thereon according to claim 1 further comprising a second protective layer disposed between the symbol and the first protective layer.

3. The structure having symbols printed thereon according to claim 1, wherein the reticulate dots are granular protrusions.

4. A method for printing symbols on a keyboard comprising a plurality of keycaps, including the steps of:
printing a plurality of symbols on the surface of a corresponding keycap of the keyboard; and
forming a first protective layer having a plurality of reticulate dots over the plurality of symbols on the surface of the keycap of the keyboard.

5. The method for printing symbols on a keyboard according to claim 4, wherein the plurality of symbols are printed on the surface of the keycap of the keyboard via screen printing.

6. The method for printing symbols on a keyboard according to claim 4, wherein the first protective layer is formed over the plurality of symbols on the surface of the keycap of the keyboard via transfer printing.

7. The method for printing symbols on a keyboard according to claim 4, wherein the reticulate dots are granular protrusions.

8. A method for printing symbols on a keyboard comprising a plurality of keycaps, including the steps of:
printing a plurality of symbols on the surface of a corresponding keycap of the keyboard;
forming a first protective layer having a plurality of reticulate dots over the plurality of symbols on the surface of the keycap of the keyboard, and
forming a second protective layer between the plurality of symbols and the first protective layer.

9. The method for printing symbols on a keyboard according to claim 8, wherein the plurality of symbols are printed on the surface of the keycap of the keyboard via screen printing.

10. The method for printing symbols on a keyboard according to claim 8, wherein the first protective layer is formed by means of transfer printing.

11. The method for printing symbols on a keyboard according to claim 8, wherein the second protective layer is formed by means of screen printing.

12. The method for printing symbols on a keyboard according to claim 8, wherein the reticulate dots are granular protrusions.
